(19) United States
(12) Patent Application Publication
(10) Pub. No.: US 2024/0208782 A1
(43) Pub. Date: Jun. 27, 2024

(54) Working Machine

(71) Applicant: J. C. Bamford Excavators Limited, Uttoxeter (GB)

(72) Inventors: Simon John Ratcliffe, Uttoxeter (GB); Lee Harper, Uttoxeter (GB)

(73) Assignee: J. C. Bamford Excavators Limited, Uttoxeter (GB)

(21) Appl. No.: 18/395,357

(22) Filed: Dec. 22, 2023

(30) Foreign Application Priority Data
Dec. 22, 2022 (GB) 2219583.8

(51) Int. Cl. B66F 9/065; B66F 9/075

(52) U.S. Cl. CPC B66F 9/0655; B66F 9/07531; B66F 9/07572

(57) ABSTRACT

A working machine includes a machine body defining a longitudinal axis; a ground-engaging propulsion structure to permit movement of the machine over the ground; a load-handling apparatus coupled to the machine body and moveable by a movement actuator with respect to the machine body; a first electric motor for providing power to the propulsion structure; and a drivetrain for transmitting power from the first electric motor to the propulsion structure, the drivetrain includes a drive shaft; wherein the first electric motor defines a longitudinal axis, and wherein the first electric motor longitudinal axis extends substantially horizontally; and wherein the first electric motor longitudinal axis is at substantially 90° to the drive shaft longitudinal axis, wherein the drivetrain comprises a gear train, and wherein the gear train includes a bevel gear set.

### FIELD

The present teachings relate to a working machine having a load handling apparatus and an electric motor.

### BACKGROUND

Machines including a load handling apparatus typically include a front and a rear axle supporting a machine body on which the load handling apparatus is mounted. Wheels are normally coupled to the front and rear axles, the wheels being configured to engage the ground and permit movement of the machine across the ground.

The load handling apparatus includes, for example, an extendable lifting arm moveable by one or more actuators with respect to the machine body. The lifting arm includes a load carrying implement to carry a load such that a load carried by the load carrying implement can be moved with respect to the machine body by the lifting arm.

Working machines are typically diesel-powered. However, there is a drive in the industry to move towards hybrid, electric or hydrogen powered vehicles, particularly where such vehicles are used indoors. One difficulty with this is removal of the diesel engine, since this significantly alters the weight distribution of the machine and has implications for the stability of the working machine.

Re-designing the working machine to be powered by an electric motor or motors rather than by a diesel engine can also lead to a requirement for investment in new infrastructure such as assembly lines, and reduced efficiency of assembly and maintenance operations due to the different layout of an electrically-powered machine. Other factors such as cooling must also be taken into consideration.

The present disclosure seeks to overcome or at least mitigate the problems of the prior art.

### SUMMARY

According to the first aspect of the present teaching there is a working machine comprising: a machine body, wherein the machine body defines a longitudinal axis; a ground-engaging propulsion structure to permit movement of the machine over the ground; a load-handling apparatus coupled to the machine body and moveable by a movement actuator with respect to the machine body; a first electric motor for providing power to the propulsion structure; a drivetrain for transmitting power from the first electric motor to the propulsion structure, the drivetrain comprising a drive shaft. The first electric motor defines a longitudinal axis, and wherein the first electric motor longitudinal axis extends substantially horizontally; and the first electric motor longitudinal axis is at substantially 90° to the drive shaft longitudinal axis, wherein the drivetrain comprises a gear train, and wherein the gear train comprises a bevel gear set.

The electric motor having a longitudinal axis at 90° to the drive shaft allows the electric motor to be positioned in a convenient location away from the central longitudinal axis of the working machine body. A suitable location for the electric motor can be chosen, taking weight distribution of components of the machine into consideration. The working machine can also be designed to be more similar to a working machine with an internal combustion engine. Assembly and maintenance of the working machine can thus advantageously take place using known methods and infrastructure, or at least using methods and infrastructure (such as assembly line layouts) more similar to those well-known for a working machine having an internal combustion engine. The bevel gear set advantageously allows the electric motor to be oriented at 90° to the drive shaft, providing options for the electric motor location.

The working machine may further comprise an operator cab. The operator cab may be positioned towards a first side of the machine body with respect to the machine body longitudinal axis.

The first electric motor may be located on a second side of the machine body, opposing the first side with respect to the machine body longitudinal axis.

The electric motor is thus similarly located to an internal combustion engine in a working machine of the internal combustion engine type, allowing a similar machine design, and similar assembly and maintenance operations.

The machine body may further comprise an enclosure in which the first electric motor is housed.

The enclosure may be positioned towards the second side of the machine body with respect to the machine body longitudinal axis.

The first and second sides may be located opposite one other.

An enclosure of the type known to be used in a machine powered by an internal combustion engine can be used to house the components of the electric powertrain that have replaced the internal combustion engine. Advantageously, the powertrain layout is then similar to that of a machine powered by an internal combustion engine. Assembly and maintenance of the machine can be carried out in similar operations to those used with an internal combustion engine-powered machine, improving efficiency.

The machine may further comprise a second electric motor, for providing power to the movement actuator The second electric motor may be housed within the enclosure.

The machine may further comprise at least one high voltage electric energy storage unit At least one high voltage electric energy storage unit may be housed within the enclosure.

At least one hydrogen fuel cell may be housed within the enclosure.

The machine may further comprise a power inverter associated with the first or second electric motor, the power inverter may be housed within the enclosure.

As above, housing the second electric motor, the at least one electric energy storage unit, and/or the inverter within the enclosure and therefore on the second side of the machine, opposing the operator cab, improves ease of assembly and maintenance, and improves the balance of weight distribution across the working machine. Additionally, locating these components close to one another, and in the enclosure, reduces the amount of ancillary equipment such as cooling equipment, wiring and connecting hoses that is required. As well as reducing cost, reliability is improved by this reduction in the number of parts.

The operator cab of the machine may be positioned towards a first side of the machine body with respect to the machine body longitudinal axis.

The first electric motor may be at least partially located on the first side of the machine body.

The first electric motor may be substantially wholly located on the first side of the machine body.

The first electric motor may be at least partially located beneath the operator cab.

The smaller size of the powertrain components in comparison to components of a diesel powered powertrain allows the advantageous positioning of components beneath the operator cab.

The machine body may further comprise an enclosure, the enclosure may be positioned towards a second side of the machine body, opposing the first side with respect to the machine body longitudinal axis.

The first and second sides may be located opposite one other, further comprising a second electric motor, for providing power to the movement actuator.

The second electric motor may be housed within the enclosure, and/or further comprising at least one high voltage electric energy storage unit At least one high voltage electric energy storage unit may be housed within the enclosure, and/or further comprising at least one hydrogen fuel cell.

At least one hydrogen fuel cell may be housed within the enclosure.

The machine may further comprise a power inverter associated with the first or second electric motor. The power inverter may be housed within the enclosure.

Housing the second electric motor, the at least one electric energy storage unit, and/or the inverter within the enclosure and therefore on the second side of the machine, opposing the operator cab, improves ease of assembly and maintenance, and improves the balance of load across the working machine. Additionally, locating these components close to one another, and in the enclosure, reduces the amount of equipment such as cooling equipment, wiring and connecting hoses that is required. As well as reducing cost, reliability is improved by this reduction in the number of parts.

The machine may further comprise a second electric motor, for providing power to the movement actuator.

The second electric motor may be located at least partially beneath the operator cab.

The machine may further comprise at least one high voltage electric energy storage unit.

At least one high voltage electric energy storage unit may be substantially wholly located on a second side of the machine body, opposing the first side with respect to the machine body longitudinal axis The storage unit may further comprise at least one hydrogen fuel cell, wherein at least one hydrogen fuel cell may be substantially wholly located on a second side of the machine body, opposing the first side with respect to the machine body longitudinal axis.

The machine may further comprise a drivetrain comprising a multi-speed transmission located in the drivetrain between the bevel gear set and the drive shaft.

Providing a multi-speed transmission improves efficiency of the powertrain and improves the ability of the working machine to climb gradients. In addition, a lower torque motor can be used with resulting cost benefits and an advantageous reduction of weight in the powertrain.

The volume of space envelope occupied by the bevel gear set may be less than 501.

The volume of space envelope occupied by the bevel gear set may be less than 301.

The relatively small size of the bevel gear set (e.g. in comparison to a gear set for a diesel powered drivetrain) increases flexibility of location of the gear set.

The ground-engaging propulsion structure may be exclusively powered by one or more electric motors.

Optionally the or each electric motor may be exclusively powered by at least one high voltage electric energy storage unit.

According to a second aspect of the current teaching there is a working machine comprising: a machine body, wherein the machine body defines a longitudinal axis; a ground-engaging propulsion structure to permit movement of the machine over the ground; a load-handling apparatus coupled to the machine body and moveable by a movement actuator with respect to the machine body; a first electric motor for providing power to the propulsion structure; and a drivetrain for transmitting power from the first electric motor to the propulsion structure, the drivetrain comprising a drive shaft having a longitudinal axis substantially parallel to the machine body longitudinal axis; wherein the first electric motor defines a longitudinal axis; wherein the first electric motor longitudinal axis is offset from the drive shaft longitudinal axis; wherein the first electric motor longitudinal axis is substantially parallel to the drive shaft longitudinal axis; and wherein the drivetrain comprises a gear train, and wherein the gear train comprises a gear set of at least two gears between the first electric motor and the drive shaft, said at least two gears having parallel axes of rotation with respect to one another and with respect to the drive shaft longitudinal axis.

As above, where a working machine of this type comprises an internal combustion engine rather than an electric motor, it is typical for the internal combustion engine to be offset from the longitudinal axis of the working machine. Locating an electric motor that has replaced the internal combustion engine in an offset position reduces the extent of alterations that must be made to the machine body design, and to assembly and maintenance infrastructure and operations.

In addition, the electric motor being offset from the longitudinal axis of the working machine improves ease of access to the motor for maintenance.

The gear axes of rotation may define a plane, and said plane may be substantially parallel to a horizontal plane defined by the machine body.

The horizontal plane may be horizontal when the working machine is positioned on horizontal ground.

The electric motor is thus similarly located to an internal combustion engine in a working machine of the internal combustion engine type, allowing a similar machine design, and similar assembly and maintenance operations.

The machine body may comprise an enclosure in which the first electric motor is housed, and the enclosure may be positioned towards the second side of the machine body with respect to the machine body longitudinal axis, and the first and second sides may be located opposite one other.

An enclosure of the type known to be used in a machine powered by an internal combustion engine can be used to house the components of the electric powertrain that have replaced the internal combustion engine. Advantageously, the powertrain layout is then similar to that of a machine powered by an internal combustion engine. Assembly and maintenance of the machine can be carried out in similar operations to those used with an internal combustion engine-powered machine, improving efficiency.

The machine may further comprise a second electric motor, for providing power to the movement actuator, the second electric motor may be housed within the enclosure.

The machine may further comprise at least one high voltage electric energy storage unit, and at least one high voltage electric energy storage unit may be housed within the enclosure, and/or further comprising at least one hydrogen fuel cell, wherein at least one hydrogen fuel cell is housed within the enclosure.

The machine may further comprise a power inverter associated with the first or second electric motor, wherein the power inverter is housed within the enclosure.

As above, housing the second electric motor, the at least one electric energy storage unit, and/or the inverter within the enclosure and therefore on the second side of the machine, opposing the operator cab, improves ease of assembly and maintenance, and improves the balance of load across the working machine. Additionally, locating these components close to one another, and in the enclosure, reduces the amount of equipment such as cooling equipment, wiring and connecting hoses that is required. As well as reducing cost, reliability is improved by this reduction in the number of parts.

The machine may further comprise an operator cab, the operator cab may be positioned towards a first side of the machine body with respect to the machine body longitudinal axis.

The first electric motor is at least partially located on the first side of the machine body.

The first electric motor may be substantially wholly located on the first side of the machine body.

The first electric motor may be at least partially located beneath the operator cab.

The smaller size of the powertrain components in comparison to components of a diesel powered powertrain allows the advantageous positioning of components beneath the operator cab.

The load handling apparatus may comprise a carriage on which one or more of a fork-type implement.

The fork-type implement may be rotatable with respect to a lifting arm of the load handling apparatus; a shovel; and a grab can be interchangeably mounted.

### BRIEF DESCRIPTION OF THE DRAWINGS

Embodiments disclosed herein will now be described, by way of example only, with reference to the accompanying drawings, in which:

FIG. 1 is a side view of a working machine on horizontal ground;

FIG. 2 is an isometric view of the machine body of the working machine of FIG. 1;

FIG. 3 is a schematic view of a layout of a working machine according to a first embodiment;

FIG. 4 is a schematic view of a layout of a working machine according to a further embodiment;

FIG. 5 is a schematic view of a layout of a working machine according to a further embodiment;

FIG. 6 is a schematic view of a layout of a working machine according to a further embodiment;

FIG. 7 is a schematic view of a layout of a working machine according to a further embodiment;

FIG. 8 is a schematic view of a layout of a working machine according to a further embodiment;

FIG. 9 is a schematic view of a layout of a working machine according to a further embodiment;

FIG. 10 is a schematic view of a layout of a working machine according to a further embodiment;

FIG. 11 is a schematic view of a gear set of a working machine according to an embodiment; and

FIG. 12 is a schematic view of a further gear set of a working machine according to an embodiment.

### DETAILED DESCRIPTION

In the following detailed description, numerous specific details are set forth in order to provide a thorough understanding of various embodiments and the inventive concept. However, those skilled in the art will understand that: the present invention may be practiced without these specific details or with known equivalents of these specific details; that the present invention is not limited to the described embodiments; and, that the present invention may be practiced in a variety of alternative embodiments. It will also be appreciated that well known methods, procedures, components, and systems may not have been described in detail.

References to vertical and horizontal in the present disclosure should be understood to be in relation to the machine when stood on horizontal ground in a non-working condition. The term axial is generally used in relation to the longitudinal axis of the machine. The term width is generally used in relation to the longitudinal length, that is, transverse to the length.

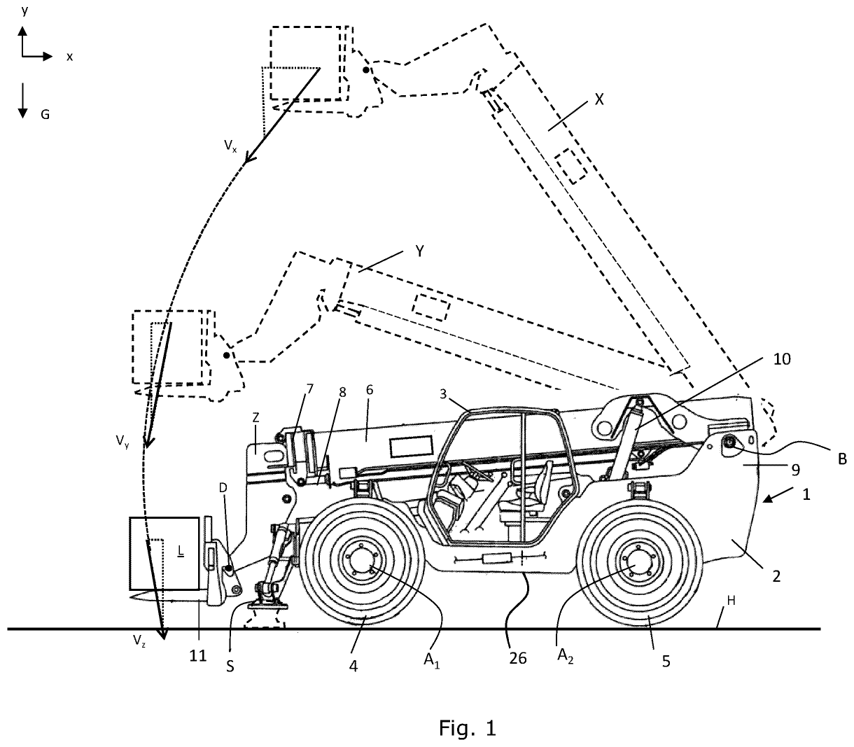

With reference to FIG. 1, an embodiment of the teachings includes a machine 1 which may be a load handling machine. In this embodiment the load handling machine is a telescopic handler. In other embodiments the load handling machine may be a skid-steer loader, a compact track loader, a wheel loader, a telescopic wheel loader, or a slew excavator, for example. Such machines may be denoted as off-highway working machines.

The working machine 1 includes a machine body 2 which includes an operator's cab 3 from which an operator can operate the working machine 1. In an embodiment, the working machine 1 has a ground engaging propulsion structure comprising a first axle A1 and a second axle A2, each axle being coupled to a pair of wheels (two wheels 4, 5 are shown in FIG. 1 with one wheel 4 connected to the first axle A1 and one wheel 5 connected to the second axle A2). In this embodiment, the first axle A1 is a front axle and the second axle A2 is a rear axle. One or both of the axles A1, A2 are coupled to a motor (discussed in further detail below) which is configured to drive movement of one or both pairs of wheels 4, 5. The wheels can contact a ground surface H and rotation of the wheels 4, 5 can cause movement of the machine with respect to the ground surface. In other embodiments the ground engaging propulsion structure comprises tracks.

In an embodiment, at least one of the first and second axles A1, A2 is coupled to the machine body 2 by a pivot joint (not shown) located at substantially the center of the axle such that the axle can rock about a longitudinal axis of the working machine 1—thus improving stability of the working machine 1 when moving across uneven ground. It will be appreciated that this effect can be achieved in other known manners.

A load handling apparatus 6, 7 is coupled to the machine body 2. The load handling apparatus 6, 7 is in this embodiment mounted by a mount 9 to the machine body 2. In this embodiment, the load handling apparatus 6, 7 includes a lifting arm 6, 7.

The lifting arm 6, 7 is in this embodiment a telescopic arm having a first section 6 connected to the mount 9 and a second section 7 which is telescopically fitted to the first section 6. In this embodiment, the second section 7 of the lifting arm 6, 7 is telescopically moveable with respect to the first section 6 such that the lifting arm 6, 7 can be extended and retracted. Movement of the first section 6 with respect to the second section 7 of the lifting arm 6, 7 is in this embodiment achieved by use of an extension actuator 8. In this embodiment, the extension actuator 8 is a double acting hydraulic linear actuator.

In some embodiments, movement of the first section 6 with respect to the second section 7 is achieved by use of an electric linear actuator, a telescopic extension ram, multiple extension rams, and/or a chain and pulley system.

One end of the extension actuator 8 is coupled to the first section 6 of the lifting arm 6, 7 and another end of the extension actuator 8 is coupled to the second section 7 of the lifting arm 6, 7 such that extension of the extension actuator 8 causes extension of the lifting arm 6, 7 and retraction of the extension actuator 8 causes retraction of the lifting arm 6, 7. As will be appreciated, the lifting arm 6, 7 may include a plurality of sections: for example, the lifting arm 6, 7 may comprise two, three, four or more sections. Each arm section may be telescopically fitted to at least one other section.

The lifting arm 6, 7 can be moved with respect to the machine body 2 and the movement is preferably, at least in part, rotational movement about the mount 9 (about pivot B of the lifting arm 6, 7). The rotational movement is about a substantially transverse axis towards the rear of the working machine 1, the pivot B being transversely arranged.

Rotational movement of the lifting arm 6, 7 with respect to the machine body 2 is, in an embodiment, achieved by use of at least one lifting actuator 10 coupled, at one end, to the first section 6 of the lifting arm 6, 7 and, at a second end, to the machine body 2. The lifting actuator 10 is a double acting hydraulic linear actuator, but may alternatively be single acting. In some embodiments, the lifting actuator is an electric linear actuator.

FIG. 1 shows the lifting arm 6, 7 positioned at three positions, namely X, Y and Z, with positions X and Y shown in dashed lines in simplified form. When positioned at position X the angle between the lifting arm and a ground level is 55 degrees. This angle is measured with respect to the longitudinal major portion of the lifting arm 6, 7, i.e. the part that extends and retracts if the arm is telescopic. In other embodiments, a different measure of the angle may be used, for example an angle defined using a notional line between the pivot B and a pivot D for the load handling implement.

When positioned at position Y the angle is 27 degrees. When positioned at position Z the angle is −5 degrees. 55 degrees and −5 degrees represent the upper and lower limits of angular movement for the working machine 1 with stabilizers retracted. In this embodiment, the upper limit is permitted to be increased to 70 degrees when stabilizers are deployed to contact the ground. Clearly, the lifting arm can be positioned at any angle between these limits. Other machines may have different upper and lower angular limits dependent upon the operational requirements of the machine (maximum and minimum lift height and forward reach etc.) and the geometry of the machine and load handling apparatus (e.g. position of pivot B, dimensions of cranked portion at the distal end of the second section 7 of the lifting arm 6, 7). As will be appreciated, when the lifting arm is positioned relatively close to the ground it is at a relatively small angle and when it is positioned relatively remotely from the ground it is at a relatively large or high angle.

In this embodiment, a load handling implement 11 is located at a distal end of the lifting arm 6, 7. The load handling implement 11 may include a fork-type implement which may be rotatable with respect to the lifting arm 6, 7 about the pivot D, this pivot also being transversely arranged. Other implements may be fitted such as shovels, grabs etc. Movement of the load handling implement 11 is in this embodiment achieved by use of a double acting linear hydraulic actuator (not shown) coupled to the load handling implement 11 and the distal end of the section 7 of the lifting arm 6, 7.

Off-highway machines 1 of the teachings are configured to transport loads L over uneven ground. That is, an operator can control the propulsion structure to move the entire machine with the load from one location to another, with a load held by the load handling implement 11.

In the illustrated embodiment, the operator cab 3 has a fixed angular orientation with respect to the front and/or rear axles A1 and A2.

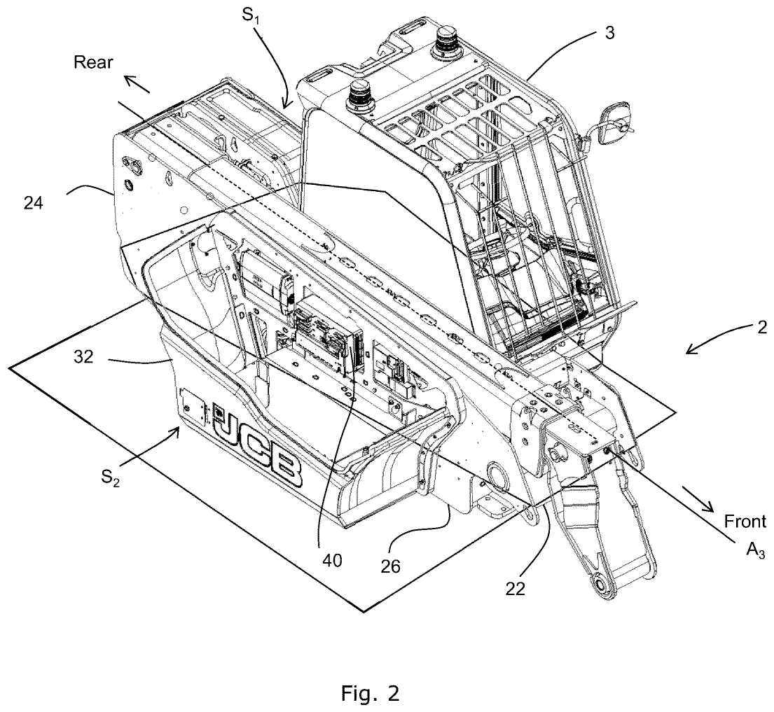

With reference to FIG. 2, the working machine 1 is an electric working machine having an electric energy storage unit for providing electrical power to the working machine 1. As shown in FIG. 2, the working machine 1 has a longitudinal axis A3. The operator cab 3 is located towards a first side S1 of the working machine 1 with respect to the longitudinal axis A3. The working machine 1 has a second side S2 with respect to the longitudinal axis A3. The first and second sides S1, S2 are located opposite one other.

As referred to herein, the term “side” is used to mean a surface of the working machine that is not the top or bottom with respect to the normal orientation of the machine, and is not the front or back with respect to the direction of travel of the machine over ground.

With reference to FIG. 2, the machine body 2 has a front 22, a rear 24, a first side S1 and a second side S2. The body 2 also includes a base 26 which, in normal use of the machine, faces the ground. The base 26 may extend, partially or entirely, between the front 22, rear 24, and/or sides S1, S2 of the working machine 1.

In the illustrated embodiment, the machine body 2 of the working machine 1 includes an enclosure 32 that may be used for housing components such as the electric storage unit and powertrain components. In some embodiments, the enclosure 32 comprises a lid (not shown) for access to the components housed within the enclosure 32.

In some embodiments, the enclosure does not have a lid. Access to the components housed within the enclosure may only be required by trained technicians, in which case, the components can be accessed without requiring the enclosure to have a lid.

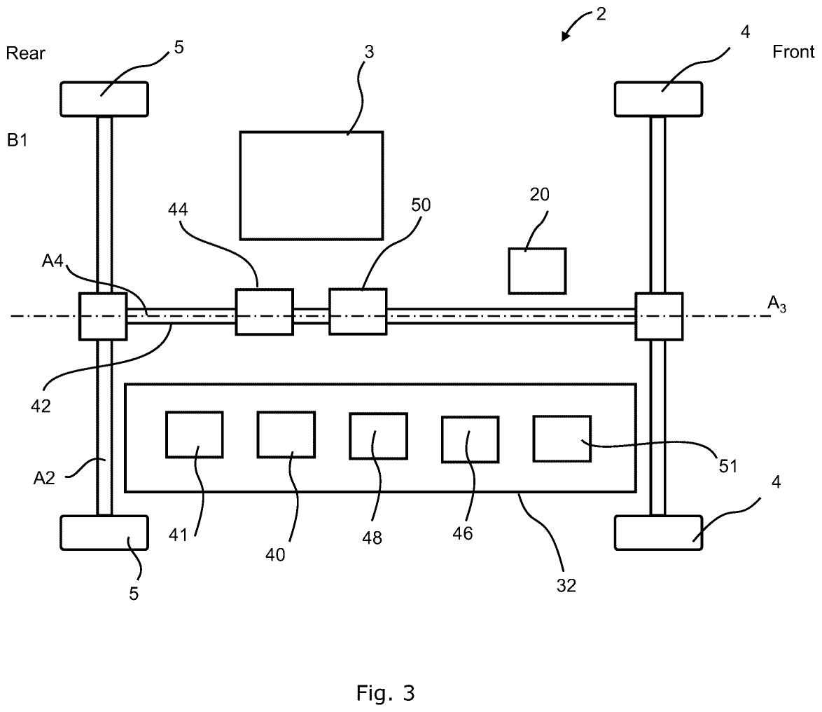

A layout of components of a first embodiment is shown in FIG. 3. In this embodiment, the working machine 1 has a machine body 2, components for which are shown in schematic form in FIG. 3. The machine body 2 shares the longitudinal axis A3 of the working machine 1. The working machine 1 has a ground engaging propulsion structure. In this embodiment, the ground engaging propulsion structure is in the form of first and second axles, A1, A2, front wheels 4 and rear wheels 5, as set out above.

The working machine 1 has a load handling apparatus 6, 7 as described above in relation to FIG. 1. The load handling apparatus 6, 7 is coupled to the machine body 2 and is moveable by a movement actuator 8.

In this embodiment, the working machine 1 has a first electric motor 40. The first electric motor 40 provides power to the propulsion structure A1, A2 via a drivetrain. The drivetrain includes a drive shaft 42 to which the first electric motor 40 is coupled. The drive shaft 42 has a longitudinal axis A4 that is substantially parallel to the longitudinal axis A3.

The first electric motor 40 defines a first electric motor longitudinal axis D aligned with the axis of rotation of the output shaft of the first electric motor 40. In this embodiment, the first electric motor longitudinal axis D is at substantially 90 degrees to the drive shaft longitudinal axis A4. That is, the first electric motor 40 is arranged transverse to the drive shaft 42, i.e. such that an output of the first electric motor 40 is arranged transverse to the drive shaft 42.

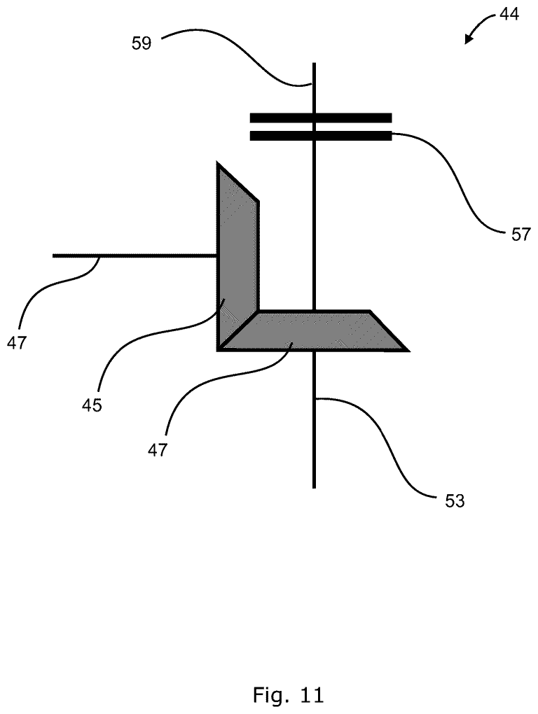

The drivetrain also includes a gear train 44. In this embodiment, the gear train includes a bevel gear set 44 including a pair of bevel gears. In this embodiment, the bevel gear set 44 is as shown in FIG. 11. A first bevel gear 45 is mounted on an input shaft 47. The first bevel gear 45 engages a second bevel gear 49 that is mounted on an output shaft 53. The bevel gears 45, 49 are arranged at 90° to one another, such that the input and output shafts 47, 53 are arranged at 90° to one another. In this embodiment, the bevel gear set 44 includes a clutch 57 and a related additional output shaft 59, to provide four wheel drive. In an alternative embodiment, e.g. where four wheel drive is not required, no such clutch and further output shaft is provided.

One advantage of the working machine 1 being powered by an electric motor 40 in place of a diesel engine is a reduction in size of the drivetrain components. The bevel gear set 44 of this embodiment has a space envelope with a volume in the range of 51 to 501. In an alternative embodiment, the bevel gear set has a space envelope with a volume in the range of 101 to 301.

The bevel gear set 44 between the first electric motor 40 and the drive shaft 42 enables the first electric motor 40 to be positioned transverse to the drive shaft 42. The first electric motor 40 being transverse to the drive shaft 42 advantageously provides freedom to locate the first electric motor 40 in a range of different locations, i.e. design freedom is provided. Advantageously, the weight distribution of the components of the working machine 1 can be taken into consideration, and a machine that was originally designed for an internal combustion engine can be powered by an electric motor or motors without compromising stability. Existing infrastructure and operations for assembly and maintenance of a working machine designed for use within an internal combustion engine can be taken into account.

As stated above in relation to FIG. 2, in the working machine 1 of this embodiment the operator cab 3 is positioned towards a first side S1 of the machine body S2 with respect to the machine body longitudinal axis A3. The first electric motor 40 is located on the second side S2 of the machine body 2. In this embodiment, the first electric motor 40 is wholly located on the second side S2 of the machine body 2. That is, the body of the motor 40 is fully located on the second side S2 of the machine body, with no part of the body of the first electric motor 40 extending over the machine body longitudinal axis A3.

Location of the first electric motor 40 on the second side S2 of the machine body 2 goes some way to providing a counterbalance to the operator cab 3 with respect to the longitudinal axis A3. In this way, weight on the working machine 1 is more evenly distributed. Advantageously, the consistency of lateral stability of the machine 1 is improved, which leads to improved lift capacity at high lifting arm angles. Advantageously, a lighter machine structure can be used, as the requirement for counterweight to minimize offset in mass is reduced, leading to increased efficiency. Where the machine 1 includes a side-shift carriage, load handling capability is improved.

In this embodiment, the first electric motor 40 is housed within the enclosure 32. As shown in FIGS. 2 and 3, the enclosure 32 is located on the second side S2 of the machine body 2, i.e. the opposite side of the machine body 2 to the cab 3. A power inverter 41 associated with the first electric motor 40 is in this embodiment also housed in the enclosure 32.

As described above, it is typical for a diesel-powered working machine to have an enclosure corresponding to the enclosure 32 of the illustrated embodiment, and for such an enclosure to house the diesel engine and to provide a counterweight to the operator cab 3. Housing the first electric motor 40 in the enclosure 32 allows the design of the working machine 1 to remain consistent with that of a diesel-powered working machine, with advantages as set out above. Load on the working machine 1 can be more evenly distributed.

The working machine 1 of this embodiment includes a second electric motor 46 for providing power to the movement actuator 8. The second electric motor 46 powers a hydraulic pump 48 in order to actuate the actuator 8. The second electric motor 46 is housed within the enclosure 32. In this embodiment, a power inverter 51 associated with the second electric motor 46 is also housed in the enclosure, as is the hydraulic pump 48. Housing these components within the enclosure further balances the load on the working machine 1.

Since two separate motors 40, 46 are used to drive the drive shaft 42 and actuate the load handling apparatus 6, 7 respectively, the drive motor 40 can be much smaller than a diesel engine used on an equivalent diesel powered working machine. Consequently, the motor 40 can be positioned with more design flexibility, as compared to an equivalent diesel powered machine. A simpler and smaller coupling between the motor 40 and the drive shaft 42 can be used. In alternative embodiments (not shown) the machine has a further motor for power steering.

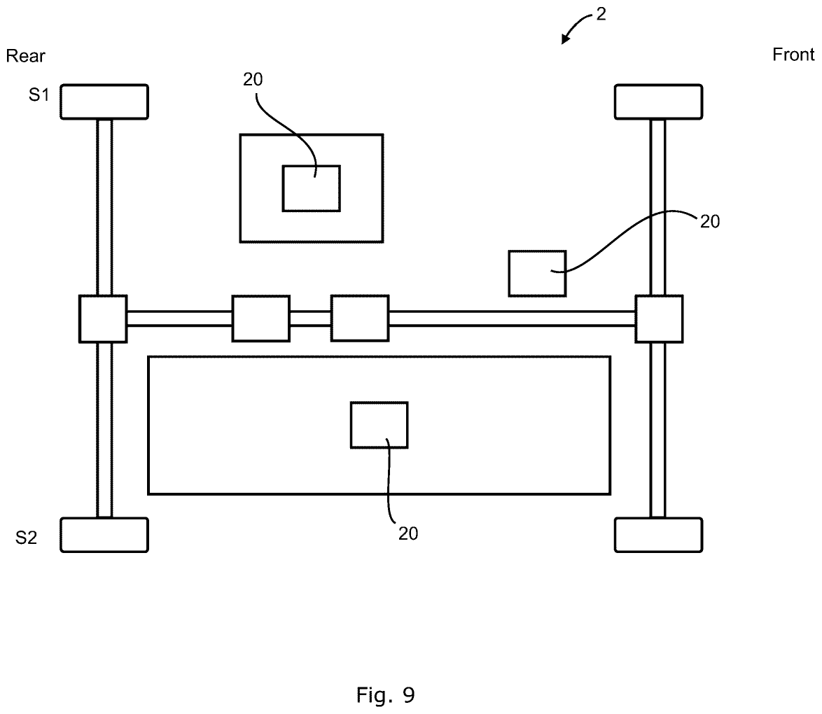

The working machine 1 has at least one, and in some embodiments two, three or more electric energy storage units 20. In the embodiment shown in FIG. 3, the electric energy storage unit is located on the first side S1 of the machine body 2. As shown in FIG. 9, the electric energy storage unit or units 20 can also or alternatively be housed or located on the second side S2 of the machine body 2. In one embodiment, an electric energy storage unit 20 is housed within the enclosure 32. In one embodiment, an electric energy storage unit 20 is located beneath the operator cab.

The electric energy storage unit 20 is in this embodiment a high voltage electric energy storage unit, i.e. of the type suitable for supplying electric energy to a motor used to provide power to a propulsion structure. The electric energy storage unit 20 is in this embodiment a high voltage battery. In alternative embodiments, the electric energy storage unit is some other suitable electric energy storage device, such as a capacitor, or a combination of a battery and a capacitor.

Housing multiple components such as motors, inverters, pumps and/or electric energy storage units within the enclosure reduces the amount of connecting equipment such as wiring, and planning required. Cooling can be limited to a smaller area, i.e. so that a reduced number of fans, e.g. a single fan, may be required for cooling. Advantageously, the cost of cooling equipment, wiring, and hoses for e.g. cooling is thus limited. Reliability is improved, as there are fewer parts in which faults could occur.

In this embodiment, the drivetrain includes a multi-speed transmission 50. The transmission 50 is located between the bevel gear set 44 and the drive shaft 42, and in this embodiment is distanced from the drive shaft 42, e.g. by a “dropbox”. The multi-speed transmission 50 may be a 2, 3, or 4 gear transmission. The multi-speed transmission 50 may be a continuously variable transmission. Providing a multi-speed transmission 50 improves efficiency of the powertrain and improves the ability of the working machine 1 to climb gradients. In addition, a lower torque, higher speed output motor can be used with resulting cost benefits and an advantageous reduction of weight in the powertrain components, as components such as transmissions can be smaller.

In alternative embodiments, no such multi-speed transmission is provided. In an alternative embodiment, a single-speed transmission is provided.

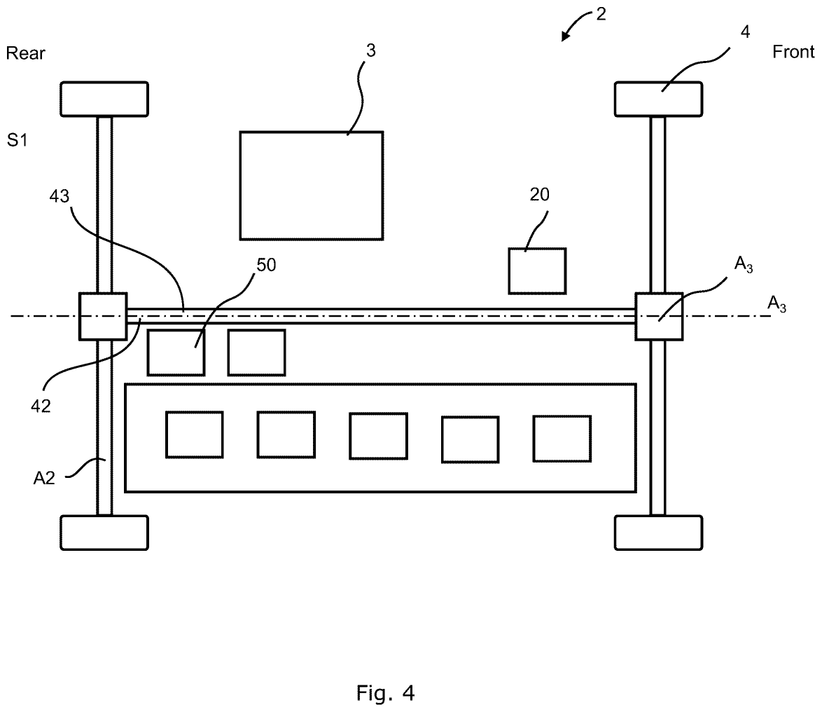

With reference now to FIG. 4, an alternative configuration of the powertrain components of the working machine 1 is shown. This configuration is similar to the configuration of FIG. 3. Detailed description is provided only of those components and arrangements that differ from those of the embodiment shown in FIG. 3.

In the layout of the embodiment of FIG. 4, the working machine has a first drive shaft 42 and a second drive shaft 43. In this embodiment, both drive shafts 42, 43 have longitudinal axes parallel to the longitudinal axis A3 of the machine body 2. In alternative embodiments, the drive shaft longitudinal axis or axes are not parallel to the longitudinal axis A3 of the machine body 2.

The first drive shaft 42 is connected in the drivetrain between the multi-speed transmission 50 and the rear axle A2. The second drive shaft 43 is connected in the drivetrain between the rear axle A2 and the front axle A1, to transfer drive from the rear axle A2 to the front axle A1.

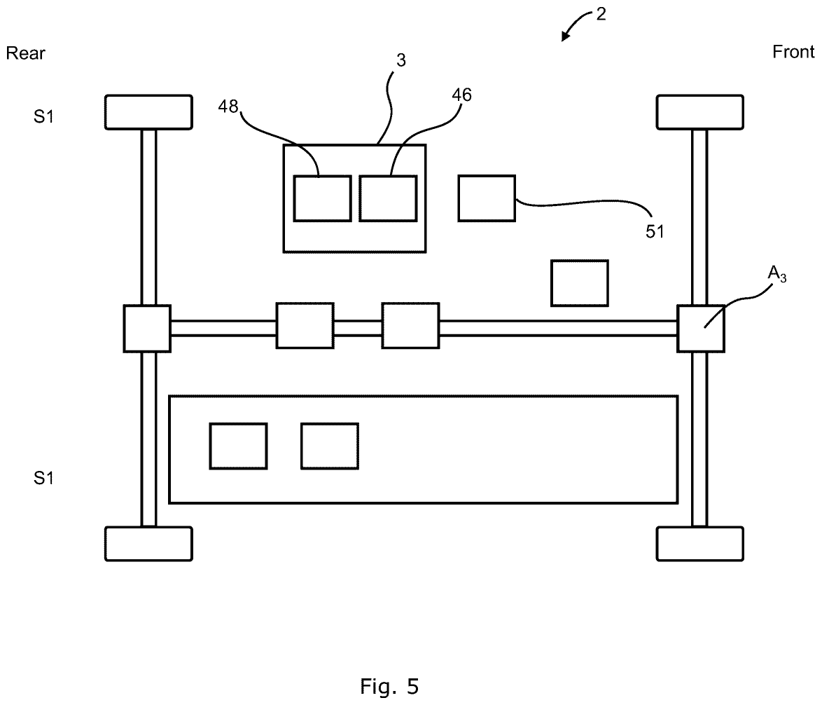

With reference now to FIG. 5, an alternative configuration of the powertrain components of the working machine 1 is shown. This configuration is similar to the configuration of FIGS. 3 and 4. Detailed description is provided only of those components and arrangements that differ from those of the embodiment shown in FIG. 3.

In the layout of the embodiment of FIG. 5, the second electric motor 46 is located on the first side S1 of the machine body 2. In this embodiment, the second electric motor 46 is located beneath the operator cab 3. In this embodiment, the hydraulic pump 48 is likewise located on the first side S1 of the machine body 2, and is in this embodiment located beneath the operator cab 3. In this embodiment, the power inverter 51 associated with the second electric motor 46 is located on the first side S1 of the machine body 2. Although shown in FIG. 5 as extending only partly beneath the operator cab 3, in one embodiment, the power inverter 51 is located beneath the operator cab 3 to a greater extent than that indicated in FIG. 5, or is wholly located beneath the operator cab 3. The relatively small size of these components 46, 48, 51 advantageously allows them to be situated beneath the operator cab 3, thus saving space in the machine body 2 and allowing flexibility of design.

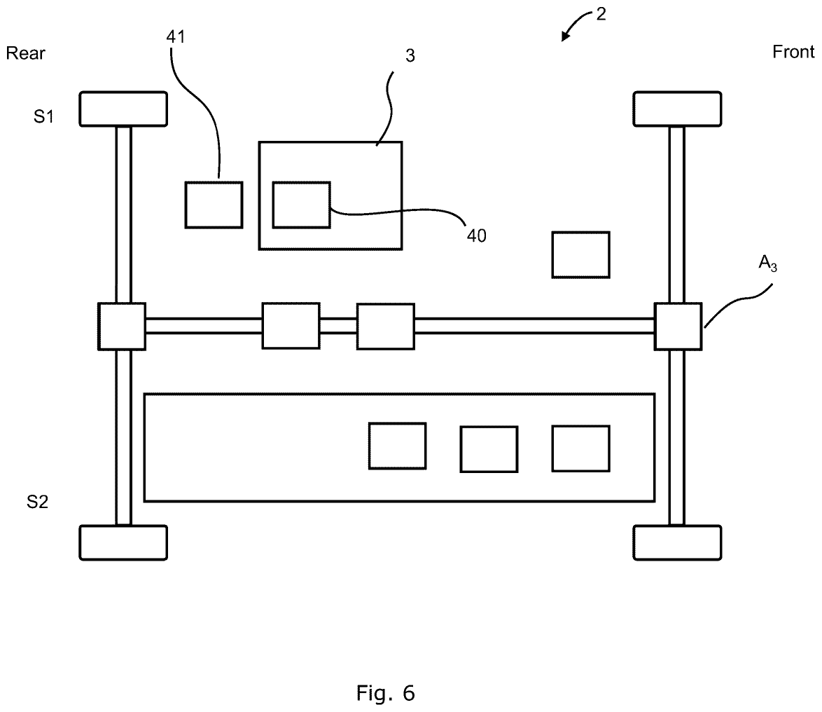

With reference now to FIG. 6, an alternative configuration of the powertrain components of the working machine 1 is shown. This configuration is similar to the configurations of FIGS. 3, 4 and 5. Detailed description is provided only of those components and arrangements that differ from those of the embodiment shown in FIG. 3.

In the layout of the embodiment shown in FIG. 6, the first electric motor 40 is located on the first side S1 of the machine body 2. In this embodiment, the first electric motor 40 is located beneath the operator cab 3, i.e. between the operator cab 3 and the ground H. In this embodiment, the power inverter 41 associated with the first electric motor 40 is also located on the first side S1 of the machine body 2. The relatively small size of the first electric motor 40 in comparison to an internal combustion engine of the type commonly used in such working machines allows the first electric motor 40 to be advantageously positioned beneath the operator cab, providing flexibility of design. The bevel gear set 44 also provides this flexibility of design, allowing the first electric motor 40 to be located beneath the operator cab 3.

In a further embodiment (not shown) both first and second electric motors 40, 46, and their associated inverters 41, 51, are located on the first side S1 of the machine body 2. In a further embodiment (not shown) both first and second electric motors 40, 46, and their associated inverters 41, 51 are located beneath the operator cab 3 of the machine body 2.

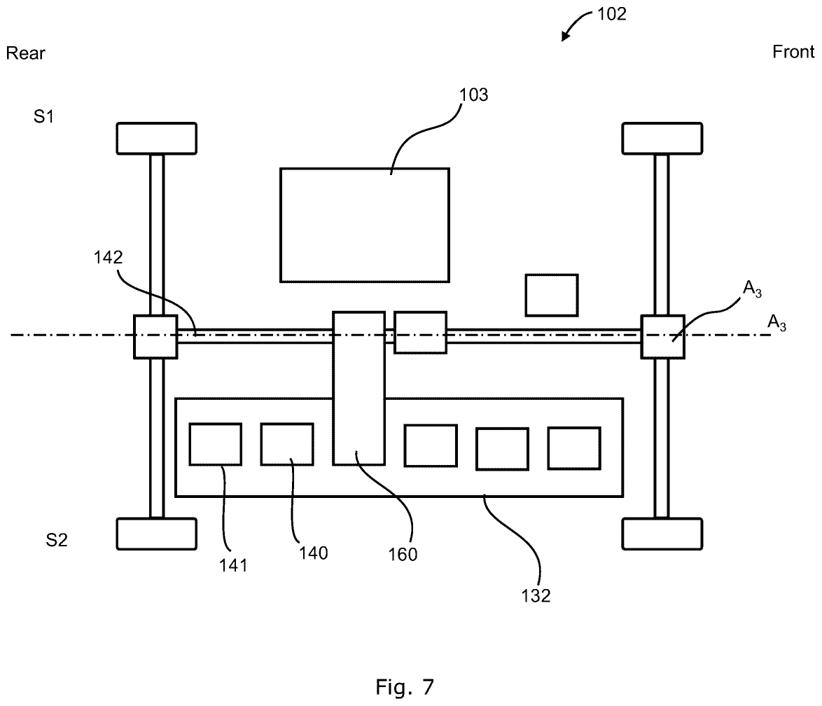

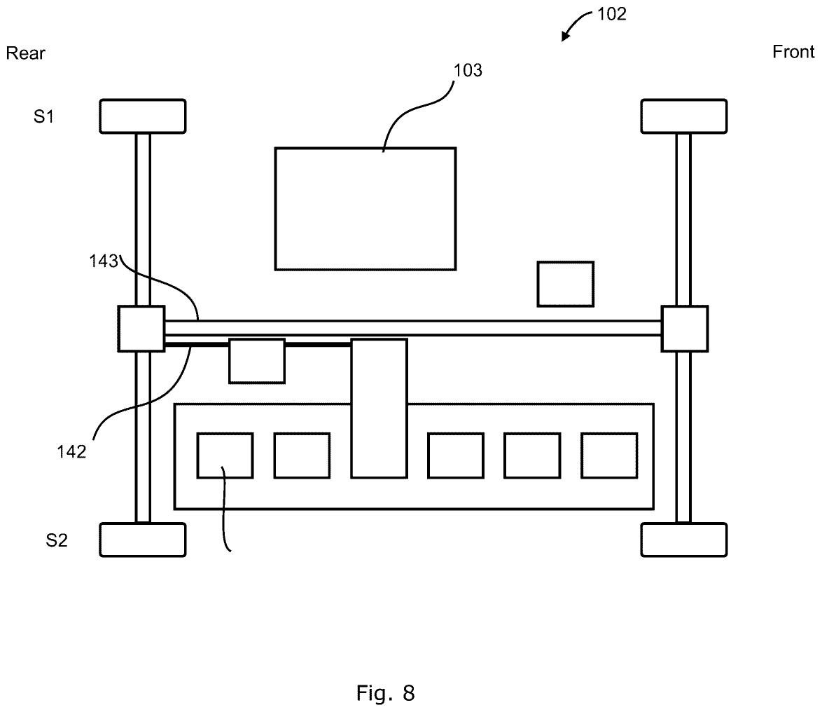

With reference now to FIGS. 7 and 8, an alternative embodiment of the working machine 1 is shown. In FIGS. 7 and 8, components corresponding to those of the previous embodiments are given the same numbering with an additional prefix “1”. Only those features which differ from the previous embodiment will be described in detail.

In this embodiment, the longitudinal axis D of the first electric motor 140 is substantially parallel to the drive shaft longitudinal axis A4. The first electric motor 40 is offset from the machine body longitudinal axis A3. That is, the first electric motor 140 is distanced from the longitudinal axis A3 in a horizontal direction—that is in a plane P as shown in FIG. 2, defined by the machine body 2, i.e. horizontal when the working machine is on level ground. No part of the body of the first electric motor 140 extends over the longitudinal axis A3, e.g. as shown in FIGS. 7 and 8.

Locating the first electric motor 140 in an offset position with respect to the longitudinal axis A3 can be used to improve stability of the working machine as weight can be distributed about the machine body 2, and the weight of the first electric motor 140 can be used to counterbalance the weight of the operator cab 103, for example. In this embodiment, the first electric motor 140 is offset towards the second side S2 of the machine body 2, such that the weight of the first electric motor 140 somewhat counterbalances the weight of the operator cab 103.

In this embodiment, the drivetrain includes a gear set 160 arranged between the first electric motor 140 and the drive shaft 142. The gear set 160 is in the form of a “dropbox”. That is, the gear set 160 is in the form of at least two gears arranged with rotational axes in parallel to one another. In this embodiment, the gear set 160 is arranged such that drive is transferred in a substantially horizontal overall direction, i.e. substantially parallel to the plane P.

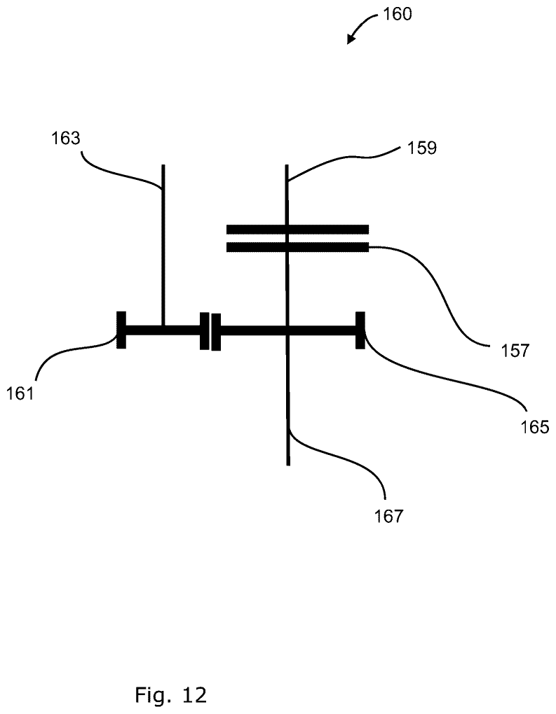

One potential layout of such a gear set 160 is shown in FIG. 12. A first gear 161 is supported on an input shaft 163. The first gear 161 engages a second gear 165 supported on an output shaft 167. The input and output shafts 163, 167 are parallel to one another.

In this embodiment, the gear set 160 includes a clutch 157 and a related additional output shaft 159, to provide four wheel drive. In an alternative embodiment, e.g. where four wheel drive is not required, no such clutch and further output shaft is provided.

The first electric motor 140 being offset from the longitudinal axis A3 allows the first electric motor 140 to be housed within the enclosure 132, with the benefits as set out above in relation to the previous embodiments. The gear set 160 advantageously allows the first electric motor 140 to be offset to this extent. The gear set 160 extends between the drive shaft 142 into the enclosure 132, to facilitate the positioning of the first electric motor 140 within the enclosure 132.

An alternative layout to that shown in FIG. 7 is shown in FIG. 8, in which embodiment the drivetrain comprises a first drive shaft 142 and a second drive shaft 143 in a layout similar to that of FIG. 4.

As described above, FIG. 9 shows different locations for an electric energy storage unit or units 20. One or more electric energy storage units 20 can be relocated in one or more of the positions shown in FIG. 9 in any of the embodiments described herein. That is, one or more electric energy storage units 20 can be located or housed on the second side S2 of the machine body 2, housed within the enclosure 32, and/or located beneath the operator cab.

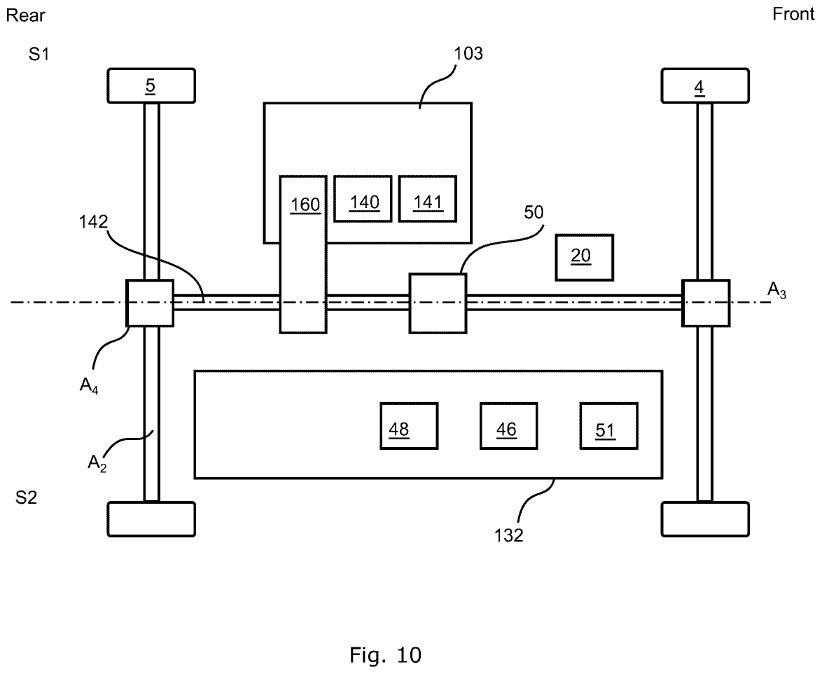

In an alternative embodiment shown in FIG. 10, the first electric motor 140 is located beneath the operator cab, with the advantages as set out above in relation to similar embodiments. As in the embodiments of FIGS. 7 and 8, in this embodiment, the drivetrain includes a gear set 160 arranged between the first electric motor 140 and the drive shaft 142. The gear set 160 is in the form of a “dropbox”. That is, the gear set 160 is in the form of at least two gears arranged with rotational axes in parallel to one another. In this embodiment, the gear set 160 is arranged such that drive is transferred in a substantially horizontal overall direction, i.e. substantially parallel to the plane P.

In the embodiments described herein a single electric motor is provided for providing power to the propulsion structure. In alternative embodiment (not shown) more than one electric motor is provided for providing power to the propulsion structure. For example, in one embodiment, one electric motor is used to power the front axle A1, and a second electric motor is used to drive the rear axle A2. In one embodiment, one electric motor is used to drive the front axle and two electric motors are used to drive the rear axle. In one embodiment, two motors are used to power the front axle and one motor is used to power the rear axle. In such embodiments, one or more of the motors is located beneath the cab, and/or within the enclosure. In a further embodiment, an electric motor is provided for each wheel. Further suitable arrangements of electric motors can be used.

The same applies to alternative drive shaft arrangements. The drivetrain of further embodiments includes other suitable drive shaft arrangements to those shown herein.

Where the or each electric energy storage unit is housed within the enclosure, or located beneath the operator cab, ease of assembly and access for servicing is improved. In alternative embodiments, the or each electric energy storage unit is located more centrally, i.e. closer or close to the longitudinal axis A3. In this case, the electric storage unit is protected from e.g. debris.

In alternative embodiments, a hydrogen fuel cell is used in place of or in addition to one or more electric energy storage units. In such embodiments, said fuel cell or cells are located in the positions of the electric energy storage units described above.

In alternative embodiments (not shown), multiple electric motors are provided for providing power to the working functions of the machine, e.g. to actuate the load handling apparatus. That is, multiple hydraulic pumps are provided, each for carrying out a separate function. Each pump has an associated electric motor. In some embodiments, one or more of these multiple electric motors and the associated pumps is or are housed in the enclosure, advantageously limiting complexity of installation and complexity of ancillary equipment such as wiring. In some embodiments, one or more of the electric motors and associated pump is located beneath the operator cab.

As can be seen most clearly from the Figures, the powertrain components and electric energy storage unit/s are positioned between the front and rear axles A1 and A2 of the working machine 1. In the illustrated embodiments, these components do not extend beyond the position of the front and rear axles A1 and A2 in a direction parallel to the longitudinal axis A3. Further, both the operator cab 3 and components are easily accessible in this location.

The operator cab 3 is also positioned between the front and rear axles A1 and A2. In the illustrated embodiment, the operator cab 3 does not extend beyond the position of the front and rear axles A1 and A2 in a direction parallel to the longitudinal axis A3.

The one or more embodiments are described above by way of example only and it will be appreciated that the variations are possible without departing from the scope of protection afforded by the appended claims.

1. A working machine comprising:
a machine body, wherein the machine body defines a longitudinal axis;
a ground-engaging propulsion structure to permit movement of the machine over the ground;
a load-handling apparatus coupled to the machine body and moveable by a movement actuator with respect to the machine body;
a first electric motor for providing power to the propulsion structure; and a drivetrain for transmitting power from the first electric motor to the propulsion structure, the drivetrain comprising a drive shaft; wherein the first electric motor defines a longitudinal axis, and wherein the first electric motor longitudinal axis extends substantially horizontally; and wherein the first electric motor longitudinal axis is at substantially 90° to the drive shaft longitudinal axis, wherein the drivetrain comprises a gear train, and wherein the gear train comprises a bevel gear set.

2. The machine according to claim 1, further comprising an operator cab, wherein the operator cab is positioned towards a first side of the machine body with respect to the machine body longitudinal axis, and wherein the first electric motor is located on a second side of the machine body, opposing the first side with respect to the machine body longitudinal axis.

3. The machine according to claim 2, wherein the machine body comprises an enclosure in which the first electric motor is housed, and wherein the enclosure is positioned towards the second side of the machine body with respect to the machine body longitudinal axis, and wherein the first and second sides are located opposite one other.

4. The machine according to claim 3, further comprising a second electric motor, for providing power to the movement actuator, wherein the second electric motor is housed within the enclosure.

5. The machine according to claim 3, further comprising at least one high voltage electric energy storage unit, wherein at least one high voltage electric energy storage unit is housed within the enclosure, and/or further comprising at least one hydrogen fuel cell, wherein at least one hydrogen fuel cell is housed within the enclosure.

6. The machine according to claim 3, further comprising a power inverter associated with the first or second electric motor, wherein the power inverter is housed within the enclosure.

7. The machine according to claim 2, wherein the operator cab is positioned towards a first side of the machine body with respect to the machine body longitudinal axis, and wherein the first electric motor is at least partially located on the first side of the machine body.

8. The machine according to claim 7, wherein the first electric motor is substantially wholly located on the first side of the machine body.

9. The machine according to claim 7, wherein the first electric motor is at least partially located beneath the operator cab.

10. The machine according to claim 7, wherein the machine body comprises an enclosure, and wherein the enclosure is positioned towards a second side of the machine body, opposing the first side with respect to the machine body longitudinal axis, and wherein the first and second sides are located opposite one other, further comprising a second electric motor, for providing power to the movement actuator, wherein the second electric motor is housed within the enclosure, and/or further comprising at least one high voltage electric energy storage unit, wherein at least one high voltage electric energy storage unit is housed within the enclosure, and/or further comprising at least one hydrogen fuel cell, wherein at least one hydrogen fuel cell is housed within the enclosure.

11. The machine according to claim 10, further comprising a power inverter associated with the first or second electric motor, wherein the power inverter is housed within the enclosure.

12. The machine according to claim 1, further comprising a second electric motor, for providing power to the movement actuator, wherein the machine comprises an operator cab, and wherein the second electric motor is located at least partially beneath the operator cab.

13. The machine according to claim 1, further comprising at least one high voltage electric energy storage unit, wherein at least one high voltage electric energy storage unit is substantially wholly located on a second side of the machine body, opposing the first side with respect to the machine body longitudinal axis, and or further comprising at least one hydrogen fuel cell, wherein at least one hydrogen fuel cell is substantially wholly located on a second side of the machine body, opposing the first side with respect to the machine body longitudinal axis.

14. The machine according to claim 1, wherein the drivetrain further comprises a multi-speed transmission located in the drivetrain between the bevel gear set and the drive shaft.

15. The machine according to claim 1, wherein the volume of space envelope occupied by the bevel gear set is less than 501, optionally wherein the volume of space envelope occupied by the bevel gear set is less than 301.

16. The machine according to claim 1, wherein the ground-engaging propulsion structure is exclusively powered by one or more electric motors.

17. The machine according to claim 16, wherein the or each electric motor is exclusively powered by at least one high voltage electric energy storage unit.

18. The machine according to claim 1, wherein the load handling apparatus comprises a carriage on which one or more of a fork-type implement; a shovel; and a grab can be interchangeably mounted.

19. The machine according to claim 18, wherein said fork-type implement is rotatable with respect to a lifting arm of the load handling apparatus.

20. The machine according to claim 1, comprising a single electric motor for providing power to the propulsion structure.
